(19) United States
(12) Patent Application Publication
(10) Pub. No.: US 2017/0248819 A1
(43) Pub. Date: Aug. 31, 2017

(54) LIQUID CRYSTAL PANELS AND LIQUID CRYSTAL DISPLAYS

(71) Applicant: Wuhan China Star Optoelectronics Technology Co., Ltd., Wuhan, Hubei (CN)

(72) Inventor: Yuejun TANG, Shenzhen, Guangdong (CN)

(73) Assignee: Wuhan China Star Optoelectronics Technology Co., Ltd., Wuhan, Hubei (CN)

(21) Appl. No.: 14/902,399

(22) PCT Filed: Dec. 30, 2015
(86) PCT No.: PCT/CN2015/099714

§ 371 Date: Dec. 31, 2015

(30) Foreign Application Priority Data
Dec. 18, 2015 (CN) 201510964504.X

(51) Int. Cl. G02F 1/1335

(52) U.S. Cl. CPC G02F 1/133555; G02F 2203/09

(57) ABSTRACT

A display panel and a display are disclosed. The display panel includes a top substrate, a down substrate, a top photoresist layer arranged on one side of the down substrate facing toward the top substrate, and a down photoresist layer arranged on one side of the top substrate facing toward the top substrate. The display panel includes a transmission area and a reflective area, and the reflective area comprises a reflective layer between the top photoresist layer and the down photoresist layer. Light beams within the transmission area pass through the top photoresist layer and the down photoresist layer, and the light beams within the reflective area pass through the top photoresist layer twice or pass through the down photoresist layer twice. In this way, the saturation of the transmission area and the reflective area are compatible.

### BACKGROUND OF THE INVENTION

1. Field of the Invention

The present disclosure relates to liquid crystal display technology, and more particularly to a liquid crystal panel and a liquid crystal display (LCD).

2. Discussion of the Related Art

LCDs are the most popular displays. The LCDs may include transflective LCDs and reflective LCDs in view of the adopted light sources. The light source of the transflective LCD is backlight. Only 5% of light beams are utilized after the light beams passing through polarizers and the liquid crystal panel. The power consumption of the backlight may be increased in order to enhance the brightness of the transflective LCDs. When the optical density of the ambient lights is greater than the light beams emitted from the LCD, it is possible that human eyes are not capable of viewing the contents displayed on the LCD. The reflective LCDs perform display by the ambient lights, and thus can only operate during day time or when the ambient light is enough, that is, the reflective LCDs cannot operate during night time or when the ambient light is weak. Thus, the transflective LCDs have been developed. The transflective LCDs adopt the backlight and the ambient lights as the light source in accordance with the environment.

With respect to the conventional transflective LCD, the light beams emitted from the transmission area of the backlight source pass through the photoresist layer once. Within the reflective area, the ambient lights may pass the photoresist layer twice during the incident and the reflective process. As such, the saturation of the reflective area may be too high and the light transmission rate of the reflective area may be lowered down. The saturation of the transmission area is not compatible with that of the reflective area. That is, the saturations of the transmission area and reflective area cannot meet product specification and demand.

### SUMMARY

The object of the invention is to provide a liquid crystal panel and LCD to overcome the incompatible saturations of the transmission area and the reflective area regarding the transflective liquid crystal panel.

In one aspect, a display panel includes: a top substrate, a down substrate, a top photoresist layer arranged on one side of the down substrate facing toward the top substrate, and a down photoresist layer arranged on one side of the top substrate facing toward the top substrate; the display panel includes a transmission area and a reflective area, and the reflective area includes a reflective layer between the top photoresist layer and the down photoresist layer; light beams within the transmission area pass through the top photoresist layer and the down photoresist layer, and the light beams within the reflective area pass through the top photoresist layer twice or pass through the down photoresist layer twice; the display panel is a single-side display panel, the display panel further includes a light source arranged on one side of the down substrate facing away the top substrate; the reflective layer is arranged on the down photoresist layer, and a reflective surface of the reflective layer faces toward the top substrate; and the reflective layer is a metallic reflective layer.

Wherein a thickness of the top photoresist layer is the same with the thickness of the down photoresist layer, and the top photoresist layer is made by the same material with the down photoresist layer.

In another aspect, a display panel includes: a top substrate, a down substrate, a top photoresist layer arranged on one side of the down substrate facing toward the top substrate, and a down photoresist layer arranged on one side of the top substrate facing toward the top substrate; the display panel includes a transmission area and a reflective area, and the reflective area includes a reflective layer between the top photoresist layer and the down photoresist layer; and light beams within the transmission area pass through the top photoresist layer and the down photoresist layer, and the light beams within the reflective area pass through the top photoresist layer twice or pass through the down photoresist layer twice.

Wherein the display panel is a single-side display panel, and the display panel further includes a light source arranged on one side of the down substrate facing away the top substrate; and the reflective layer is arranged on the down photoresist layer, and a reflective surface of the reflective layer faces toward the top substrate.

Wherein a thickness of the top photoresist layer is the same with the thickness of the down photoresist layer, and the top photoresist layer is made by the same material with the down photoresist layer.

Wherein a thickness of the top photoresist layer is different from the thickness of the down photoresist layer, and the top photoresist layer is made by material different from the material of the down photoresist layer; and a saturation of the light beams within the transmission area, passing through the top photoresist layer and the down photoresist layer, and the saturation of the light beams within the reflective area, passing through the top photoresist layer twice, are the same.

Wherein the display panel is a double-sided display panel, the display panel further includes a light source arranged on one side of the down substrate facing away the top substrate, and the reflective layer is arranged on the down photoresist layer, and a reflective surface of the reflective layer faces toward the top substrate.

Wherein a thickness of the top photoresist layer is the same with the thickness of the down photoresist layer, and the top photoresist layer is made by the same material with the down photoresist layer.

Wherein a thickness of the top photoresist layer is different from the thickness of the down photoresist layer, and the top photoresist layer is made by material different from the material of the down photoresist layer; and a saturation of the light beams within the transmission area, passing through the top photoresist layer and the down photoresist layer, and the saturation of the light beams within the reflective area, passing through the top photoresist layer twice, are the same.

Wherein the reflective layer is a metallic reflective layer.

Wherein the metallic reflective layer is aluminum foil.

In another aspect, a display includes: a display panel includes a top substrate, a down substrate, a top photoresist layer arranged on one side of the down substrate facing toward the top substrate, and a down photoresist layer arranged on one side of the top substrate facing toward the top substrate; the display panel includes a transmission area and a reflective area, and the reflective area includes a reflective layer between the top photoresist layer and the down photoresist layer; and light beams within the transmission area pass through the top photoresist layer and the down photoresist layer, and the light beams within the reflective area pass through the top photoresist layer twice or pass through the down photoresist layer twice.

Wherein the display panel is a single-side display panel, and the display panel further includes a light source arranged on one side of the down substrate facing away the top substrate; and the reflective layer is arranged on the down photoresist layer, and a reflective surface of the reflective layer faces toward the top substrate.

Wherein a thickness of the top photoresist layer is the same with the thickness of the down photoresist layer, and the top photoresist layer is made by the same material with the down photoresist layer.

Wherein a thickness of the top photoresist layer is different from the thickness of the down photoresist layer, and the top photoresist layer is made by material different from the material of the down photoresist layer; and a saturation of the light beams within the transmission area, passing through the top photoresist layer and the down photoresist layer, and the saturation of the light beams within the reflective area, passing through the top photoresist layer twice, are the same.

Wherein the display panel is a double-sided display panel, the display panel further includes a light source arranged on one side of the down substrate facing away the top substrate, and the reflective layer is arranged on the down photoresist layer, and a reflective surface of the reflective layer faces toward the top substrate.

Wherein a thickness of the top photoresist layer is the same with the thickness of the down photoresist layer, and the top photoresist layer is made by the same material with the down photoresist layer.

Wherein a thickness of the top photoresist layer is different from the thickness of the down photoresist layer, and the top photoresist layer is made by material different from the material of the down photoresist layer; and a saturation of the light beams within the transmission area, passing through the top photoresist layer and the down photoresist layer, and the saturation of the light beams within the reflective area, passing through the top photoresist layer twice, are the same.

Wherein the reflective layer is a metallic reflective layer.

Wherein the metallic reflective layer is aluminum foil.

In view of the above, the display panel includes the top substrate, the down substrate, a top photoresist layer arranged on one side of the top substrate facing toward the down substrate, and a down photoresist layer arranged on the down substrate facing toward the top substrate. The display panel includes a transmission area and a reflective area. The reflective layer is arranged within the reflective area, and is between the top photoresist layer and the down photoresist layer. The light beams within the transmission area pass through the top photoresist layer and the down photoresist layer. The light beams within the reflective area pass through the top photoresist layer or the down photoresist layer twice. By configuring two photoresist layers, the light beams within the transmission area not only pass through one photoresist layer. Instead, the light beams within the transmission area pass through the top photoresist layer and the down photoresist layer. The light beams within the reflective area pass through the top photoresist layer and the down photoresist layer twice. In this way, the saturation of the transmission area and the reflective area are compatible.

### BRIEF DESCRIPTION OF THE DRAWINGS

FIG. 1 is a schematic view of the display panel in accordance with a first embodiment.

FIG. 2 is a schematic view of the display panel in accordance with a second embodiment.

FIG. 3 is a schematic view of the LCD in accordance with one embodiment.

### DETAILED DESCRIPTION OF THE EMBODIMENTS

Embodiments of the invention will now be described more fully hereinafter with reference to the accompanying drawings, in which embodiments of the invention are shown.

FIG. 1 is a schematic view of the display panel in accordance with a first embodiment. The display panel 100 includes a top substrate 11, a down substrate 12, a top photoresist layer 13, a down photoresist layer 14, and a reflective layer 15.

Generally, the substrate of the display panel may include a glass substrate, and thin film transistors (TFTs) arranged on the glass substrate. The photoresist layer is also called as the color filter layer. The reflective layer is generally adopted in the reflective display panel. The other portions of the display panel 100 may be conceived by persons in the ordinary skill and thus are omitted hereinafter.

The top substrate 11 and the down substrate 12 are opposite to each other, and the liquid crystals are filled therebetween. The top photoresist layer 13 is arranged on the top substrate 11, and the top photoresist layer 13 faces toward the down substrate 12. The down photoresist layer 14 is arranged on the down substrate 12, and the down photoresist layer 14 faces toward the top substrate 11.

The display panel 100 is of transflective type, and includes a transmission area 101 and a reflective area 102. The reflective area 102 further includes the reflective layer 15 arranged between the top photoresist layer 13 and the down photoresist layer 14. The reflective layer 15 is made by reflective materials, such as Al, Ag, and Cu. The manufacturing process of the metallic materials is simple, and the reflective effect is good. In an example, the aluminum foil may be adopted. The gross, the reflective effect, and the extensibility of the aluminum are good and suitable for manufacturing process of the reflective layer.

If a reflective surface 151 of the reflective layer 15 faces toward the top photoresist layer 13, the light beams within the reflective area 102 may pass through the top photoresist layer 13 twice. If a reflective surface 151 of the reflective layer 15 faces toward the down photoresist layer 14, the light beams within the reflective area 102 may pass through the down photoresist layer 14 twice. Under the two conditions, the light beams within the reflective area 102 pass through the photoresist twice. The light beams within the transmission area 101 pass through the top photoresist layer 13 and the down photoresist layer 14, that is, the light beams pass through the photoresist twice. Thus, the saturation of the reflective area 102 and that of the transmission area 101 may be compatible.

In the embodiment, only one side of the display panel 100 may display. A light source 16 of the display panel 100 is arranged on one side of the down substrate 12 facing away the top substrate 11. The reflective layer 15 is arranged on the down photoresist layer 14 and the reflective surface 151 faces toward the top substrate 11. The light source 16 is configured as a rear light source for the transmission area 101. The light beams emitted from the light source 16 cannot pass through the reflective area 102, that is, the liquid crystal panel 10 may only emit lights by the ambient lights. Specifically, the ambient lights pass through the top photoresist layer 13 and are reflected by the reflective surface of the reflective layer 15. The reflected light beams pass through the top photoresist layer 13 again so as to be observed by human eyes.

As the material and the thickness of the photoresist layer may affect the saturation of the light beams. In order to obtain compatible saturation for the reflective area 102 and the transmission area 101, the top photoresist layer 13 and the down photoresist layer 14 are made by the same material. In addition, the thickness of the top photoresist layer 13 and the down photoresist layer 14 are the same.

In one example, the top photoresist layer 13 and the down photoresist layer 14 may be made by different materials, and the thickness of the top photoresist layer 13 and the down photoresist layer 14 may be respectively configured. In other words, the materials and the thickness of the top photoresist layer 13 and the down photoresist layer 14 may be respectively configured such that the saturation of the light beams within the transmission area 101, passing through the top photoresist layer 13 and the down photoresist layer 14, and the saturation of the light beams within the reflective area 102, passing through the top photoresist layer 13 twice, may be the same.

Referring to FIG. 1, it is to be noted that the cell thickness of the display panel 100 with respect to the transmission area 101 and the reflective area 102 are the same. In real applications, the cell thickness may be different. In FIG. 1, the same cell thickness regarding the transmission area 101 and the reflective area 102 is only one example, that is, the cell thickness of the transmission area 101 and the reflective area 102 are not limited thereto. For the display panels wherein different thicknesses being configured with respect to the transmission area and the reflective area, the above configuration of the photoresist layer may also be employed.

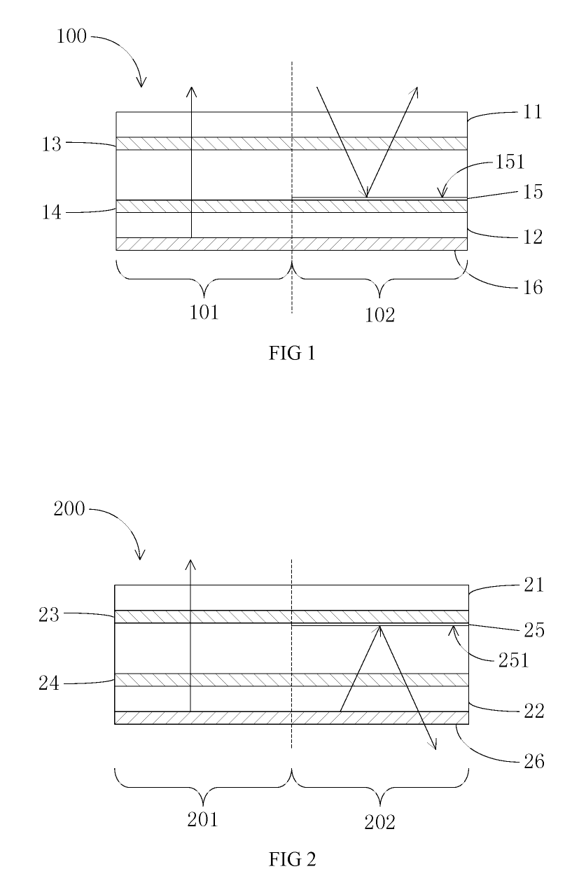

FIG. 2 is a schematic view of the display panel in accordance with a second embodiment. The display panel 200 includes a top substrate 21, a down substrate 22, a top photoresist layer 23, a down photoresist layer 24, and a reflective layer 25.

The top photoresist layer 23 is arranged on the top substrate 21. The down photoresist layer 24 is arranged on the down substrate 22. The light source 200 includes the transmission area 201 and the reflective area 202. A reflective layer 25 is arranged between the top photoresist layer 23 and the down photoresist layer 24 within the reflective area 202.

The structure of the display panel 200 is substantially the same with that of the display panel 100. The difference between the display panel 100 and the display panel 200 resides in that the display panel 200 is a double-sided display panel. The light source 26 is arranged on one side of the down substrate 22 facing away the top substrate 21. The reflective layer 25 is arranged on the 23 is arranged on the 23 and the reflective layer 25 faces toward the down substrate 22. That is, the light beams from the reflective area 202 pass through the down photoresist layer 24 twice.

With respect to the display panel 200, the light source 26 is configured as the rear light source for the transmission area 201. The light beams from the light source 26 pass through the down photoresist layer 24 and the top photoresist layer 23 and are observed by human eyes. With respect to the reflective area 202, the light source 26 is configured as the front light source. The light beams from the light source 26 pass through the down photoresist layer 24, arrives the reflective layer 25, and are reflected. The reflected light beams pass through the down photoresist layer 24 and then are observed by human eyes.

In order to obtain compatible saturation for the reflective area 202 and the transmission area 201, the thickness of the top photoresist layer 23 and the down photoresist layer 24 are the same.

In one example, the top photoresist layer 23 and the down photoresist layer 24 may be made by different materials, and the thickness of the top photoresist layer 13 and the down photoresist layer 14 may be respectively configured. As such, the saturation of the light beams within the transmission area 201, passing through the top photoresist layer 23 and the down photoresist layer 24, and the saturation of the light beams within the reflective area 202, passing through the down photoresist layer 24 twice, may be the same.

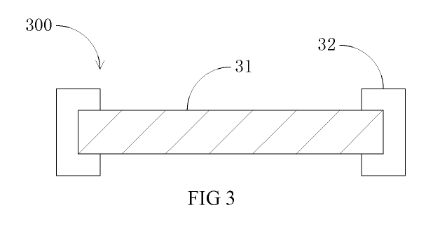

FIG. 3 is a schematic view of the LCD in accordance with one embodiment. The LCD 300 includes a display panel 31 and a border 32. The display panel 31 may be the above display panel 100 or the display panel 200. The border 32 is configured to fix and to protect the display panel 31.

In view of the above, the display panel includes the top substrate, the down substrate, a top photoresist layer arranged on one side of the top substrate facing toward the down substrate, and a down photoresist layer arranged on the down substrate facing toward the top substrate. The display panel includes a transmission area and a reflective area. The reflective layer is arranged within the reflective area, and is between the top photoresist layer and the down photoresist layer. The light beams within the transmission area pass through the top photoresist layer and the down photoresist layer. The light beams within the reflective area pass through the top photoresist layer or the down photoresist layer twice. By configuring two photoresist layers, the light beams within the transmission area not only pass through one photoresist layer. Instead, the light beams within the transmission area pass through the top photoresist layer and the down photoresist layer. The light beams within the reflective area pass through the top photoresist layer and the down photoresist layer twice. In this way, the saturation of the transmission area and the reflective area are compatible.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display panel, comprising:
a top substrate, a down substrate, a top photoresist layer arranged on one side of the down substrate facing toward the top substrate, and a down photoresist layer arranged on one side of the top substrate facing toward the top substrate;
the display panel comprises a transmission area and a reflective area, and the reflective area comprises a reflective layer between the top photoresist layer and the down photoresist layer;
light beams within the transmission area pass through the top photoresist layer and the down photoresist layer, and the light beams within the reflective area pass through the top photoresist layer twice or pass through the down photoresist layer twice;
the display panel is a single-side display panel, the display panel further comprises a light source arranged on one side of the down substrate facing away the top substrate;
the reflective layer is arranged on the down photoresist layer, and a reflective surface of the reflective layer faces toward the top substrate; and
the reflective layer is a metallic reflective layer.

2. The display panel as claimed in claim 1, wherein a thickness of the top photoresist layer is the same with the thickness of the down photoresist layer, and the top photoresist layer is made by the same material with the down photoresist layer.

3. A display panel, comprising:
a top substrate, a down substrate, a top photoresist layer arranged on one side of the down substrate facing toward the top substrate, and a down photoresist layer arranged on one side of the top substrate facing toward the top substrate;
the display panel comprises a transmission area and a reflective area, and the reflective area comprises a reflective layer between the top photoresist layer and the down photoresist layer; and
light beams within the transmission area pass through the top photoresist layer and the down photoresist layer, and the light beams within the reflective area pass through the top photoresist layer twice or pass through the down photoresist layer twice.

4. The display panel as claimed in claim 3, wherein the display panel is a single-side display panel, and the display panel further comprises a light source arranged on one side of the down substrate facing away the top substrate; and
the reflective layer is arranged on the down photoresist layer, and a reflective surface of the reflective layer faces toward the top substrate.

5. The display panel as claimed in claim 4, wherein a thickness of the top photoresist layer is the same with the thickness of the down photoresist layer, and the top photoresist layer is made by the same material with the down photoresist layer.

6. The display panel as claimed in claim 4, wherein a thickness of the top photoresist layer is different from the thickness of the down photoresist layer, and the top photoresist layer is made by material different from the material of the down photoresist layer; and
a saturation of the light beams within the transmission area, passing through the top photoresist layer and the down photoresist layer, and the saturation of the light beams within the reflective area, passing through the top photoresist layer twice, are the same.

7. The display panel as claimed in claim 3, wherein the display panel is a double-sided display panel, the display panel further comprises a light source arranged on one side of the down substrate facing away the top substrate, and the reflective layer is arranged on the down photoresist layer, and a reflective surface of the reflective layer faces toward the top substrate.

8. The display panel as claimed in claim 7, wherein a thickness of the top photoresist layer is the same with the thickness of the down photoresist layer, and the top photoresist layer is made by the same material with the down photoresist layer.

9. The display panel as claimed in claim 7, wherein a thickness of the top photoresist layer is different from the thickness of the down photoresist layer, and the top photoresist layer is made by material different from the material of the down photoresist layer; and
a saturation of the light beams within the transmission area, passing through the top photoresist layer and the down photoresist layer, and the saturation of the light beams within the reflective area, passing through the top photoresist layer twice, are the same.

10. The display panel as claimed in claim 3, wherein the reflective layer is a metallic reflective layer.

11. The display panel as claimed in claim 10, wherein the metallic reflective layer is aluminum foil.

12. A display, comprising:
a display panel comprises a top substrate, a down substrate, a top photoresist layer arranged on one side of the down substrate facing toward the top substrate, and a down photoresist layer arranged on one side of the top substrate facing toward the top substrate;
the display panel comprises a transmission area and a reflective area, and the reflective area comprises a reflective layer between the top photoresist layer and the down photoresist layer; and
light beams within the transmission area pass through the top photoresist layer and the down photoresist layer, and the light beams within the reflective area pass through the top photoresist layer twice or pass through the down photoresist layer twice.

13. The display panel as claimed in claim 12, wherein the display panel is a single-side display panel, and the display panel further comprises a light source arranged on one side of the down substrate facing away the top substrate; and
the reflective layer is arranged on the down photoresist layer, and a reflective surface of the reflective layer faces toward the top substrate.

14. The display panel as claimed in claim 13, wherein a thickness of the top photoresist layer is the same with the thickness of the down photoresist layer, and the top photoresist layer is made by the same material with the down photoresist layer.

15. The display panel as claimed in claim 13, wherein a thickness of the top photoresist layer is different from the thickness of the down photoresist layer, and the top photoresist layer is made by material different from the material of the down photoresist layer; and
a saturation of the light beams within the transmission area, passing through the top photoresist layer and the down photoresist layer, and the saturation of the light beams within the reflective area, passing through the top photoresist layer twice, are the same.

16. The display panel as claimed in claim 12, wherein the display panel is a double-sided display panel, the display panel further comprises a light source arranged on one side of the down substrate facing away the top substrate, and the reflective layer is arranged on the down photoresist layer, and a reflective surface of the reflective layer faces toward the top substrate.

17. The display panel as claimed in claim 16, wherein a thickness of the top photoresist layer is the same with the thickness of the down photoresist layer, and the top photoresist layer is made by the same material with the down photoresist layer.

18. The display panel as claimed in claim 16, wherein a thickness of the top photoresist layer is different from the thickness of the down photoresist layer, and the top photoresist layer is made by material different from the material of the down photoresist layer; and
a saturation of the light beams within the transmission area, passing through the top photoresist layer and the down photoresist layer, and the saturation of the light beams within the reflective area, passing through the top photoresist layer twice, are the same.

19. The display panel as claimed in claim 12, wherein the reflective layer is a metallic reflective layer.

20. The display panel as claimed in claim 12, wherein the metallic reflective layer is aluminum foil.
